(19) United States
(12) Patent Application Publication
(10) Pub. No.: US 2012/0210813 A1
(43) Pub. Date: Aug. 23, 2012

(54) ARRANGEMENT OF A GEAR AND COUPLING ELEMENT FOR TRANSMITTING A ROTATIONAL MOTION

(76) Inventors: Andreas ZELLER, Grundau (DE); Wolfgang Schiemenz, Ronshausen (DE); Rolf Schwarze, Aalen (DE)

(21) Appl. No.: 13/432,262

(22) Filed: Mar. 28, 2012

Related U.S. Application Data
(63) Continuation of application No. PCT/EP2010/003453, filed on Jun. 9, 2010.

(30) Foreign Application Priority Data
Sep. 29, 2009 (DE) 10 2009 043 367.8

(51) Int. Cl. F16H 55/12; B23P 11/00

(52) U.S. Cl. 74/431; 29/893.2

(57) ABSTRACT

The invention relates to an arrangement comprising a gear and a coupling element, which is connected to the gear in a form-fitted manner in order to transmit a rotational motion. The gear and the coupling element each have a geometry (e.g., G_{Z}, G_{K}) on end faces facing each other, which form a form-fitted connection in connection with the geometry of the other element. The gear and the coupling element are designed as components produced by sintering, into which the respective end-face geometries (G_{Z}, G_{K}) are impressed. Using these end-face geometries, the gear and the coupling element are positioned relative to each other.

### CROSS-REFERENCE TO RELATED APPLICATIONS

This application is a continuation application of PCT application serial number PCT/EP2010/003453 entitled “Arrangement of a Gear and Coupling Element for Transmitting a Rotational Motion” filed on Jun. 9, 2010 which claims priority to German patent application number 10 2009 043 367.8 filed on Sep. 29, 2009. The contents of both of these applications are incorporated by reference as if set forth in their entirety herein.

### BACKGROUND

The invention relates to an arrangement comprising a gear and a coupling element for transmitting a rotational motion and the attendant torque, wherein the arrangement is used in particular in a manual transmission of a vehicle. The vehicle can be a land vehicle, aircraft, watercraft, or a combination thereof.

According to the prior art, notably in the field of manual vehicle transmissions, such assemblies are preferably designed in the manner of a form-fitted connection, wherein a coupling element can comprise a cut-out which has a peripheral internal toothing and in which a bushing-shaped section or collar section of a gear or gear wheel having peripheral external toothing can be inserted. In addition or as an alternative, these two mating bodies can also be welded to each other, for example by means of a fusion welding method that is used in selective areas, or continuous welding at least in some regions (for example, in a circumferential direction of the arrangement) so as to suppress a relative movement of the two mating bodies. These two mating bodies and the respective geometries thereof forming the form-fitted connection are produced from a blank each using a chip-removing machining operation. For welding, the two mating bodies must undergo a finishing machining operation so as to assure precise positioning. In the aforementioned embodiment, the external toothing of the gear and the internal toothing of the coupling element must thus be machined.

These two mating bodies are, moreover, subjected to hardening. Hardening can be carried out on the individual parts or in the assembled state of the individual parts. The hardening process as such also results in undesirable dimensional warpage, which must be eliminated as part of a finishing operation by way of machining so as to assure optimally possible precise positioning.

So as to ensure that these two mating bodies have a centered effect in relation to each other and can thus assure correspondingly high positioning accuracy, moreover, a machining or finishing operation is required on the associated geometries or elements that create the form fit.

### SUMMARY

It is the object of the invention to simplify and improve the production of such assemblies. It is a further object to provide a method and use, whereby parts that are to be joined and subjected to torque can be produced with a precise fit.

This object is achieved by an arrangement described in the claims. Moreover, the description hereafter provides further advantageous characteristics, which may form the subject-matter of further embodiments and refinements of the solution. These additional characteristics may be combined with each other and/or with the characteristics as set forth in the claims.

The invention relates to an arrangement comprising a gear and a coupling element, wherein the coupling element is connected to the gear in a form-fitted manner for the transmission of a rotational motion. On end faces facing each other, the gear and the coupling element each have a geometry which, in connection with the geometry of the respective other body, creates a form-fitted connection, in particular a push-fit connection. A push-fit connection herein denotes a form-fitted connection created of at least one depression that is present on a first joining part and at least one elevation present on in a second joining part, the elevation being designed complementary to the depression. The gear and the coupling element are designed as components produced by sintering techniques, and into which the respective end-face geometries are integrally molded and/or impressed, whereby the gear and the coupling element can be positioned in relation to each other.

During production by sintering of these two mating bodies, a powdery substance is compressed to form a compressed blank, also referred to as green compact. During sintering, the compressed blank obtains its final strength in that the compressed powdery substance or compressed blank or green compact comes to constitute, when passing through a sintering oven, a continuous crystal structure as a result of diffusion and recrystallization processes. The sintering process is generally known and will not be described in detail here. Metallic materials are preferred but are not used exclusively as sintering materials. Iron-based alloys are particularly preferred materials. The metallic materials can be materials which have sufficient strength. Preferably, materials are used which are common gear materials and, within this meaning, allow for reliable torque transmission using the arrangement inside a transmission.

The advantage of the present arrangement is that end-face geometries creating the form fit do not require finishing by way of machining. This circumstance advantageously saves time and money. As a result, the production of the two mating bodies can be further, advantageously, simplified. Moreover, these geometries can advantageously be matched to each other such that any corresponding undesirable dimensional warpage of the geometries caused by the hardening process can be compensated during sintering, resulting in the advantage that finishing of the geometries is dispensed with. Another advantage of the end-face geometries is that they allow considerable freedom with respect to the geometric design.

It shall be noted that the term “form-fitted connection” was selected because any kind of form-fitted connection is possible between the mating parts to be joined. The key in designing the form-fitted connection is that a transmission of torque is enabled and/or supported using the form-fitted connection. In one embodiment, a gear and a coupling element inside a transmission are used as the mating parts to be joined. It is conceivable for the components that are to be joined to be joined using the form-fitted connection such that the center axes thereof coincide, so that force and/or torque transmission is possible based on the form fit alone.

In a preferred embodiment, these geometries of the two mating bodies have one orientation each with respect to at least one associated longitudinal axis, whereby the mating bodies advantageously have a centering effect in relation to each other. A longitudinal axis herein can, for example, denote a center axis or a center line, or, in the case of rotationally symmetrical parts, it can denote an axis of symmetry and/or center axis. Rotationally symmetrical components are preferably used as components to be joined in the transmission. In addition, the gear and the coupling element can be arranged coaxially with respect to each other constituting at least one common longitudinal axis, wherein the longitudinal axes thereof coincide, whereby the longitudinal axis forms a common center of rotation or a common rotational axis. This common longitudinal axis can, for example, be at least the center axis of the present arrangement.

In a further preferred embodiment, the geometries forming a push-fit connection are designed such that preferably at least the geometry of the gear is provided with a plurality of depressions, in which respectively one protrusion or elevation of the geometry of the coupling element engages. As an alternative or in addition, the coupling element can be provided with a plurality of depressions, in which respectively one protrusion of the gear, which has a complementary design, engages.

In a preferred embodiment, the push-fit connection is preferably designed in the manner of a spline, wherein an end face of the gear, preferably in a region between a root circle diameter and a bushing-shaped section, preferably comprises a plurality of depressions in the circumferential direction, which are spaced relative to each other by individual ridge sections, wherein the individual ridge sections preferably extend from a peripheral shoulder to the bushing-shaped section. The ridge sections are preferably uniformly spaced in relation to each other. On an end face associated with the gear, the coupling element, in contrast, comprises a plurality of tooth elements, which are arranged in the circumferential direction and each extend from the end face into one of the depressions of the gear. The geometric design of these tooth elements corresponds to the depressions in the coupling element, whereby the gear and the coupling element can be joined without play. These depressions are oriented with respect to a longitudinal axis associated with the gear, while the tooth elements are oriented with respect to a longitudinal axis associated with the coupling element, whereby the gear and the coupling element advantageously have a centering effect in relation to each other.

As an alternative or in addition, the coupling element may be provided with a plurality of depressions, for example in an analogous manner in the circumferential direction. Teeth each having a corresponding design and/or a protrusion in the gear can engage these depressions in the coupling element.

In a further preferred embodiment, the gear and the coupling element are additionally bonded to each other by a material closure adhesive force. The material closure connection is created at least in selective areas. Such a selectively adhesively bonded connection has the advantage that the related complexity for producing the same is minimal. Moreover, a selectively bonded connection such as, for example, a fusion welding operation in selective areas, has the advantage of introducing a minimal amount of heat into the components that are to be joined. As an alternative or in addition, the bonded connection can be designed to be continuous at least in some regions, for example in the circumferential direction. For the bonded connection, the gear can be welded and/or brazed and/or glued to the coupling element.

According to a further preferred embodiment, the gear and the coupling element are additionally press-fit stemmed with respect to each other, whereby a relative movement, preferably in the longitudinal direction of the two mating bodies, between the gear and the coupling element is advantageously suppressed. Press-fit stemming offers the advantage of reliable torque transmission because the mating bodies or joining parts are non-detachably connected to each other.

In this context, the bushing-shaped section or collar section of the gear preferably projects through a corresponding cut-out of the coupling element, wherein the bushing-shaped section is press-fit stemmed on the end face side at least in selective areas, preferably roller-burnished on, for the purpose of press-fit stemming. A resulting bead assures a physical connection between the gear and the coupling element, wherein the connection allows the gear to be positioned relative to the coupling element in the longitudinal direction of the arrangement.

The invention further relates to a use of an arrangement comprising a gear and a coupling element of the aforementioned type for a transmission of a vehicle, wherein the vehicle can be designed as a land vehicle, aircraft, watercraft or a combination thereof. The manual transmission can be designed as a conventional manual transmission or preferably as an automated transmission.

These and still other advantages of the invention will be apparent from the detailed description and drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE DRAWINGS

Embodiments of the invention will be described in detail hereafter with reference to the drawings. The characteristics apparent from the drawings and the associated descriptions are not limited to the respective embodiments. These characteristics also shall not be interpreted in a limiting manner. These characteristics rather serve to illustrate an exemplary implementation. Moreover, with respect to possible additional embodiments and refinements of the solution, the individual characteristics can be combined with each other and with the characteristics of the description above, wherein these additional embodiments and refinements are not shown in detail. In the drawings:

FIG. 1 is a three-dimensional view of a proposed arrangement comprising a gear and a coupling element and a cross-sectional view of the arrangement along a cutting line B-B;

FIG. 2 is a two-dimensional view of the gear shown in FIG. 1 and a cross-sectional view of the gear along a cutting line C-C;

FIG. 3 is a two-dimensional view of the coupling element shown in FIG. 1 and a cross-sectional view of the coupling element along a cutting line D-D;

FIG. 4 is a three-dimensional view of the gear which shows the side to be joined with the coupling element;

FIG. 5 is a three-dimensional view of the coupling element which shows the side to be joined with the gear;

FIG. 6 is a three-dimensional view of the coupling element which shows the side facing away from the gear;

FIG. 7 is a three-dimensional view of a further embodiment of a coupling element which shows the side to be joined with the gear;

FIG. 8 is a three-dimensional view of the coupling element according to FIG. 7 which shows the side facing away from the gear; and

FIG. 9 is a three-dimensional view of the gear which shows the side to be joined with the coupling element according to FIGS. 7 and 8.

### DETAILED DESCRIPTION OF THE PREFERRED EMBODIMENTS

Identical or similar-type components are denoted hereinafter by identical reference numerals.

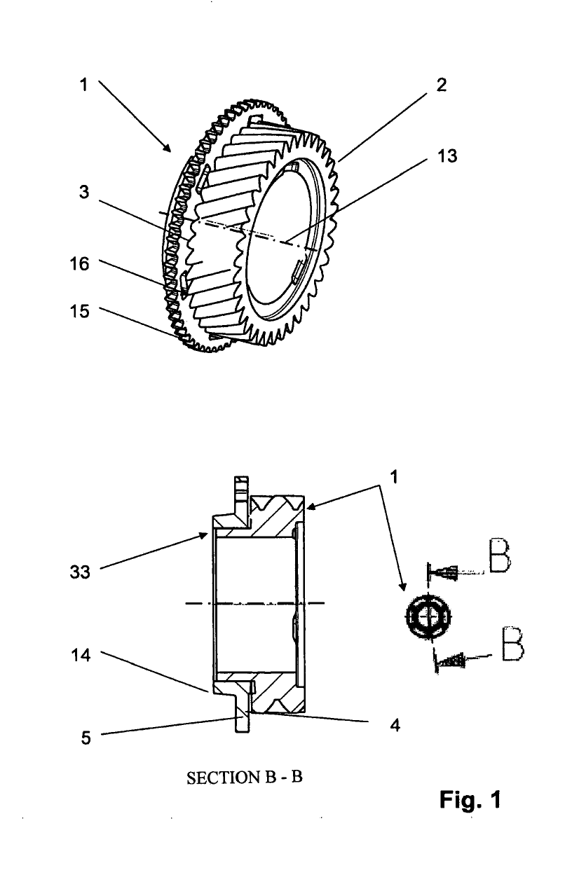

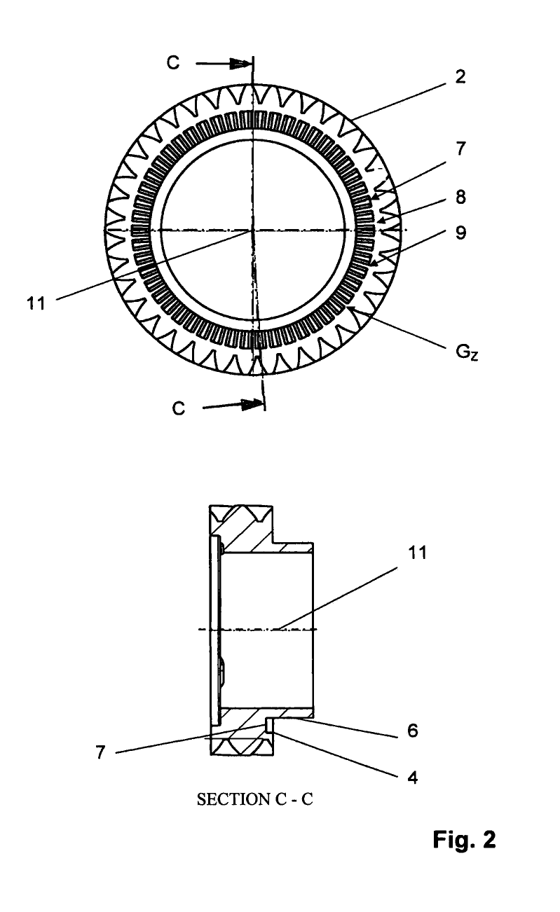

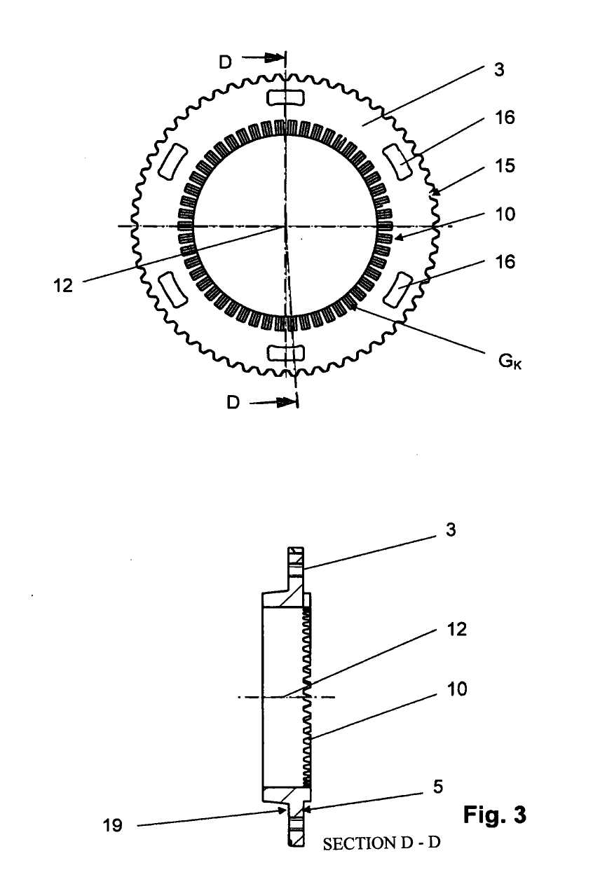

The arrangement 1 shown in FIG. 1 comprises a gear 2 as a spur gear, having preferably helical toothing, and a coupling element 3, which is connected to the gear 2 in a form-fitted manner in order to transmit torque, whereby a push-fit connection is created. The push-fit connection is preferably designed in the manner of a spline. The gear 2 and the coupling element 3 have a geometry G_{Z}, G_{K} respectively on end faces 4, 5 facing each other (see FIGS. 2 and 3), wherein the respective geometries create the spline in connection with the geometry G_{Z}, G_{K} of the respectively other body 2, 3. The gear 2 and the coupling element 3 are each preferably designed as single-piece components 2, 3, which are produced by sintering and in which the respective end-face geometries G_{Z}, G_{K} are integrally impressed and/or molded, whereby the gear 2 and the coupling element 3 can be positioned in relation to each other. As an alternative, the gear 2 and the coupling element 3 can also each be a component that is composed of two parts. The design as a sintered component constitutes a considerable improvement over the prior art mentioned in the introduction, whereby a machining operation for producing the geometries G_{Z}, G_{K} that create the spline is advantageously eliminated.

During the production by sintering of the two mating bodies 2, 3, a respective powdery substance is compressed to form a compressed blank, also referred to as a green compact, which is to be sintered. During sintering, the compressed blank obtains its final strength in that the compressed powdery substance or compressed blank or green compact, when passing through a sintering oven, creates a continuous crystal structure, primarily as a result of diffusion processes but also due to recrystallization processes. In addition to conventional sintering technology, this production by sintering shall, moreover, be understood to include sinter-forging technology, which is intended to represent a concept secondary to conventional sintering technology, in order to provide sintered components 2, 3 having greater density and strength.

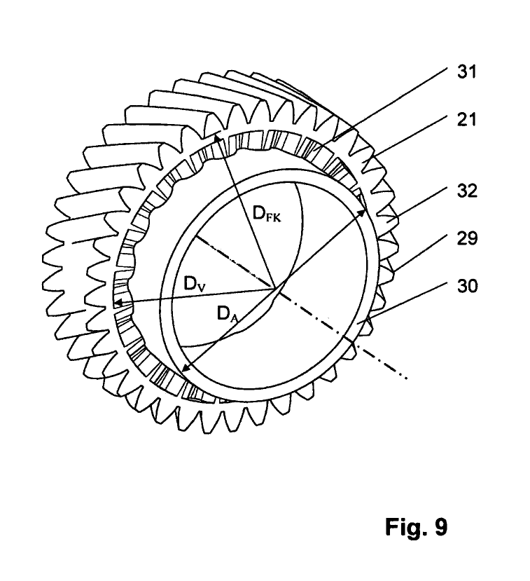

FIG. 2 shows a view of the gear 2 and a section of the gear 2 along line C-C. The illustration at the top of FIG. 2 is a top view of the gear 2, which shows the end face 4 to be joined with the coupling element 3. At an end face 4, in a region between preferably a root circle diameter D_{FK} (see FIG. 9) and a bushing-shaped section or collar section 6, the gear 2 preferably comprises a plurality of depressions 7 in the circumferential direction, which are spaced from each other by individual ridge sections 8. These individual ridge sections 8 are preferably spaced uniformly relative each other and preferably extend from a peripheral shoulder 9 to the bushing-shaped section 6, wherein the peripheral shoulder 9 is located on a diameter that is larger than an outside diameter of the collar section 6 and smaller than the root circle diameter D_{FK} of the gear 2.

FIG. 3 shows a view of a preferred embodiment of the coupling element 3 and a section of the coupling element 3 along line D-D. The illustration at the top of FIG. 3 is a view of the coupling element 3 which shows the end face 5 to be joined with the gear 2. On an end face 5 associated with the gear 2, the coupling element 3, in contrast, comprises a plurality of tooth elements 10, which are arranged in the circumferential direction and each extend from the end face 5 into one of the depressions 7, to which they correspond in terms of their geometric design. The depressions 7 are preferably oriented with respect to a longitudinal axis 11 associated with the gear 2, while the tooth elements 10 are preferably oriented with respect to a longitudinal axis 12 associated with the coupling element 3. The longitudinal axis 11 and the longitudinal axis 12 are an associated center axis, wherein these two center axes 11, 12 are preferably arranged coaxially with respect to each other and form a common longitudinal axis 13 of the arrangement 1.

In addition to this form-fitted connection, the gear 2 and the coupling element 3 can also be bonded to each other by welding and/or brazing and/or gluing the gear 2 to the coupling element 3 so as to suppress a relative movement between the two mating bodies 2, 3. The bonded connection therein is preferably created at least in selective areas. In addition or as an alternative thereto, such a bonded connection can also be designed to be continuous at least in some regions, for example in the circumferential direction.

Moreover, in addition to or as an alternative to the bonded connection, the gear 2 and the coupling element 3 may also be press-fit stemmed with respect to each other. To this end, the bushing-shaped section 6 of the gear 2 preferably projects through a corresponding cut-out 14 of the coupling element 3, wherein the bushing-shaped section 6 is roller-burnished on at least in selective areas, whereby a bead generated by a plastic deformation of the bushing-shaped section 6 assures a physical connection between the gear 2 and the coupling element 3 suppressing a relative movement between the two joining parts 2, 3.

The proposed arrangement 1 is preferably used as a component in what is known as a locking and synchronization device in a manual transmission for a vehicle, wherein the locking and synchronization device can be used to easily and silently shift a gear, provided that the selector sleeve and the coupling element 3, which, via the toothing thereof or the shift toothing 15, cooperates with the selector sleeve in a form-fitted manner so as to shift a corresponding gear having the same rotational speed. What is known as an intermediate synchronizer ring engages in the preferably rectangular cut-outs 16, which are incorporated in the coupling element 3 and spaced, preferably uniformly, from each other in the circumferential direction of the coupling element 3. For this purpose, the number of cut-outs 16 that this intermediate synchronizer ring is provided with corresponds to the number of so-called foot tabs which engage in the cut-outs 16. A basic design and a basic mode of operation of such a locking and synchronization device is described in the literature. Reference shall be made, for example, in this connection to “Fachkundebuch fur Kraftfahrzeugtechnik” from the Europa technical books series (25th edition) (see page 372) or “Kraftfahrzeugtechnisches Taschenbuch” (English title: Automotive Handbook) by Bosch (23rd edition), the descriptions of which with respect to the locking and synchronization device are hereby incorporated by reference as part of the disclosure of the present invention. The transmission can preferably also be a semi-automatic transmission.

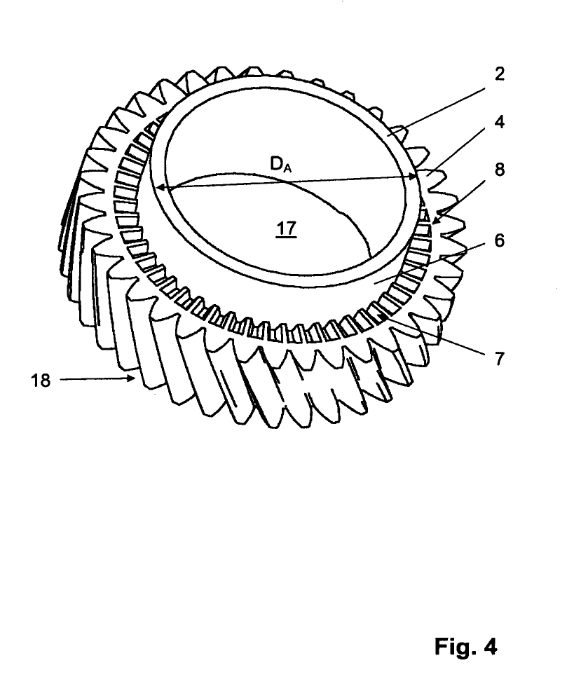

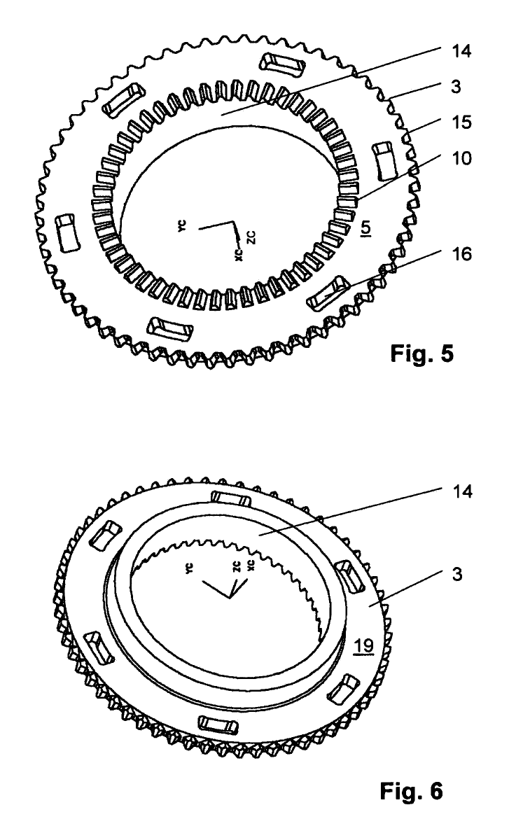

FIG. 4 shows a three-dimensional view of a gear 2. The gear comprises a bore hole 17 through which the gear 2 can be positioned on a shaft or axis. On the outer circumference, the gear 2 comprises a toothing 18 in the form of a spur gear having helical toothing. Torque or a force can be absorbed or transmitted by way of the toothing 18. In the embodiment shown, the gear 2 is designed as a single-piece sintered part. During production, the sintered part 2 is shaped, pressed and sintered with such precision that a finishing operation can be foregone, or the finishing operation is at least minimized.

Depressions 7 are integrally molded in the gear 2 as means for axial force transmission; the shape of the depressions corresponding to a negative shape of tooth elements. The depressions 7 are incorporated on a uniform diameter in the gear 2, circumferentially on the collar section 6. The depressions 7 are part of the form-fitted connection for transmitting a torque of the arrangement comprising the coupling element 3 and gear 2. The integral moldings 8 in the gear 2 form depressions 7 in the end face 4. The collar section 6 has an outside diameter D_{A} which corresponds to the cut-out 14 in the coupling element 3, wherein the collar web 6 can be inserted in the cut-out 14. When the gear 2 and the coupling element 3 are joined, the cut-out 14 is pushed over the collar web 6. The displacement is carried out until the tooth elements 10 are seated in the depressions 7. By seating the tooth elements 10 in the depressions 7 of the gear 2, a form-fitted connection for transmitting torque is established. When torque is introduced into the gear 2, for example, via the helical toothing 18, and the coupling element 3 is seated on the gear 2 in a form-fitted manner, the torque can be carried away using the shift toothing 15.

FIG. 6 shows a three-dimensional view of the coupling element 3 and a view showing the side 19 facing away from the gear 2. By sliding the coupling element 3 onto the collar ridge 6 and introducing the tooth elements 10 in the depressions 7, the gear 2 and the coupling element 3 are oriented with respect to each other such that the center axes 11, 12 of the gear 2 and coupling element 3 coincide and form a center axis 13 of the arrangement 1.

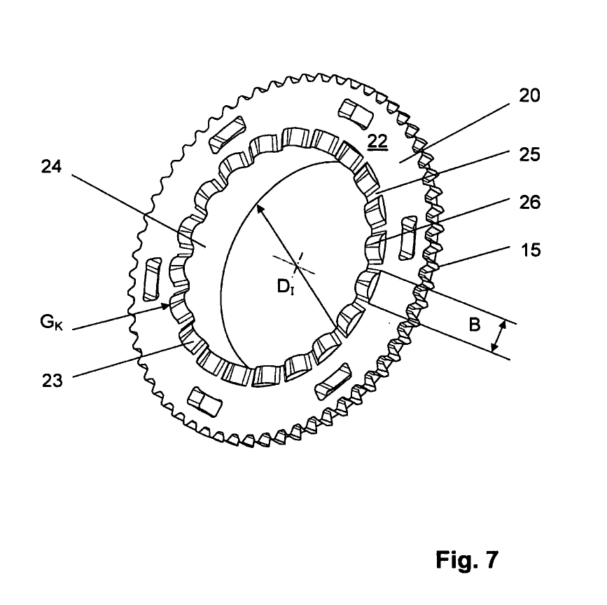

FIG. 7 shows a further embodiment of the invention, and in particular a different geometry G_{K} of a coupling element 20. It is a three-dimensional view of the end face 22 to be joined with the gear 21. With the exception of the design of the geometry G_{K}, the coupling element 20 is identical to the coupling element 3. Contrary to the coupling element 3, the elevations 23 on the end face 22 of the coupling element 20 do not form teeth, but have an undulated shape. The elevations 23 are arranged on the same diameter and regularly around the cut-out 24 on the coupling element 20. The elevations 23 project from the end face 22 and are spaced from each other by ridges 24, wherein the ridges 24 are located in one plane with the end face 22. The width B of the elevations 23 can be uniform from the inside diameter D_{I} to an outside diameter. In this embodiment according to FIG. 7, the elevations 23 have a conical design. Conical here denotes that the width B, starting from an inside diameter D_{I}, increases toward the outer shift toothing 15. The conical widening of the elevations 23 is characterized by the conical lines 26 on the undulated elevations 23.

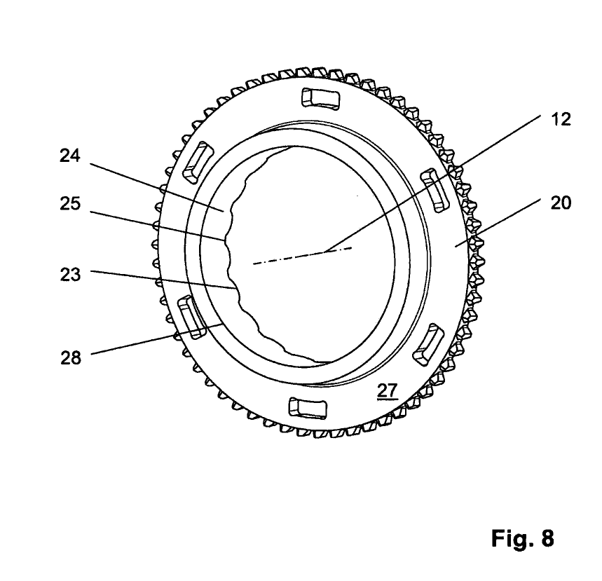

FIG. 8 shows a three-dimensional view of the coupling element 20 according to FIG. 7 in a view that shows the end face 27 facing away from the gear. A collar ridge 28 is likewise integrally molded onto the coupling element 20. The coupling element 20 has a single-piece design in this embodiment. However, it is also conceivable according to the invention to design the coupling element 20, as well as the related gear 21, in multiple pieces. The collar ridge 28 is used to further stabilize the form-fitted connection between the coupling element 20 and gear 21.

FIG. 9 shows a three-dimensional view of an alternative embodiment of a gear 21. On the circumference, the gear 21 comprises toothing 29 designed as involute helical toothing. The collar ridge 30 projects beyond the toothing 29 and forms a guide for the cut-out 24 of the coupling element 20. Depressions 31 are incorporated on the outside diameter D_{A} of the collar web 30, which are designed as depressions 31 complementary to the elevations 23; which is to say, the elevations 23 cooperate with the depressions 31 in such a manner that the elevations 23 engage with each other on the circumference in a form-fitted manner. The depressions 31 extend, starting from the outside diameter D_{A} of the collar ridge 30, to a diameter D_{V} of the depressions 31, wherein the diameter D_{V} of the depressions 31 is always smaller than the diameter D_{FK} of the foot circle of the toothing 29 of the gear 21. The depressions 31 are located in an end face 32 of the gear 21 and extend from a diameter D_{A} to a diameter D_{V}, wherein the diameter D_{V} of the depressions 31 is larger than the diameter D_{A} of the guide bushing 30 and smaller than the diameter D_{FK} of the foot circle of the toothing 29.

After the gear 2, 21 has been joined with a coupling element 3, 20, a relative position of the joined components 2, 3, 20, 21 is obtained, as it is shown by way of example in FIG. 1. After joining, the components 2, 3, 20, 21 can be connected by a material closure or mechanically. In the event of a material-closure connection, for example, the components 2, 3, 20, 21 would be welded together in the region 33, as shown in FIG. 1. However, it would also be possible to press-fit stem the components 2, 3, 20, 21 in the region 33, and in particular the collar ridges 6, 28, 30. Press-fit stemming and/or bonding increases the reliability in the transmission of a force or torque.

As is shown, the geometric design of the form-fitted connection between the gear 2, 21 and the coupling element 3, 20 is flexible. It is thus conceivable to design geometric shapes between the gear 2, 21 and the coupling element 3, 20 which have a cooperating effect and can take on any kind of shape. It is thus conceivable, for example, for the elevations 10, 23 and/or depressions 7, 31 to be present in trapezoidal, toothed, curved, sinusoidal or undulated shapes in the gear 2, 21 and/or coupling element 3, 20. Of course, it is also conceivable for the elevations 10, 23 and depressions 7, 31 in the gear 2, 21 and/or coupling element 3, 20 to have alternating designs, which is to say that elevations 10, 23 and depressions 7, 31 are sequentially configured in the gear 2,21 and/or coupling element 3, 20. A non-symmetrical arrangement of elevations 10, 23 and/or depressions 7, 31 on the circumference of the gear 2, 21 and/or coupling element 3, 20 is also conceivable. It is further conceivable for the elevations 10, 23 and/or depressions 7, 31 in the gear 2, 21 and/or coupling element 3, 21 to cooperate with the collar ridge 6, 28, 30 of the gear 2, 21 and the cut-out in the coupling element 3, 20 so as to establish a form-fitted connection. The form-fitted connection is then formed by a combination of creating a fit between the cut-out on the coupling element 3, 20 and collar ridge of the gear 2, 21 and the elevations 10, 23 and/or depressions 7, 31 in the gear 2, 21 and/or coupling element 3, 20.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. An arrangement comprising a gear and a coupling element which is connected to the gear in a form-fitted manner in order to transmit a rotational motion, wherein, on end faces facing each other, the gear and the coupling element each have a geometry which in connection with the geometry of the respective other component creates a form-fitted connection, wherein the gear and the coupling element are each designed as components produced by sintering, and wherein the respective end-face geometry is impressed into the gear and the coupling element, whereby the gear and the coupling element are positioned with respect to each other.

2. The arrangement according to claim 1, wherein the geometries have a respective orientation with respect to at least one associated longitudinal axis.

3. The arrangement according to claim 1, wherein the gear and the coupling element are arranged coaxially with respect to each other and form at least one common longitudinal axis.

4. The arrangement according to claim 1, wherein the form-fitted connection is a push-fit connection and the geometries forming the push-fit connection are designed such that at least the geometry of the gear is provided with a plurality of depressions, in which a respective protrusion of the geometry of the coupling element engages.

5. The arrangement according to claim 4, wherein the push-fit connection is designed in the manner of a spline, wherein on an end face the gear, in a region between a root circle diameter and a bushing-shaped section, the gear comprises a plurality of depressions in the circumferential direction, which are spaced from each other by individual ridge sections, wherein the individual ridge sections extend from a diameter of the depressions to a diameter of the bushing-shaped section, and wherein, on an end face associated with the gear, the coupling element comprises a plurality of elevations, which are arranged in the circumferential direction and each extend from the end face into one of the depressions, wherein the depressions are oriented with respect to a longitudinal axis associated with the gear, while the elevations are oriented with respect to a longitudinal axis associated with the coupling element.

6. The arrangement according to claim 5, wherein the ridge sections are spaced evenly from each other.

7. The arrangement according to claim 1, wherein the gear and the coupling element are connected to each other by a material closure.

8. The arrangement according to claim 7, wherein the connection by the material closure is formed at least in selective areas.

9. The arrangement according to claim 8, wherein the connection by the material closure is formed in selective areas and continuously in the circumferential direction.

10. The arrangement according to claim 8, wherein the connection by the material closure is formed continuously in the circumferential direction.

11. The arrangement according to claim 8, wherein the connection by the material closure is formed in selective areas in the circumferential direction.

12. An arrangement according to claim 7, wherein the gear is at least one of welded, brazed, and glued to the coupling element.

13. An arrangement according to claim 1, wherein the gear and the coupling element are press-fit stemmed with respect to each other.

14. The arrangement according to claim 13, wherein a bushing-shaped section of the gear projects through a corresponding cut-out of the coupling element, wherein, on the end face, the bushing-shaped section is roller-burnished on at least in selective areas, whereby a bead generated thereby assures a physical connection between the gear and the coupling element.

15. A method for producing an arrangement including a gear and a coupling element in which the coupling element is connected to the gear in a form-fitted manner in order to transmit a rotational motion, the method comprising producing the gear and the coupling element by sintering, joining the coupling element and gear in a form-fitted manner using geometries designed on end faces facing each other, wherein the respective end-face geometries are impressed into the gear and the coupling element in an upstream method step, whereby the gear and the coupling element are positioned with respect to each other.

16. The method according to claim 15, wherein the gear and the coupling element are inseparably connected after joining.

17. A manual transmission for a vehicle comprising the arrangement of claim 1 including the gear and the coupling element, wherein the vehicle is a land vehicle, aircraft, watercraft, or a combination thereof.

18. The manual transmission of claim 17, wherein the manual transmission is an automated transmission.
